(19) United States
(12) Patent Application Publication
(10) Pub. No.: US 2013/0270451 A1
(43) Pub. Date: Oct. 17, 2013

(54) Magnetic Structure For Circular Ion Accelerator

(71) Applicants: Patrick Verbruggen, Orbais (BE); Sébastien De Neuter, Jandrenouille (BE); Roberto Marabotto, Genova (IT); Alessio Capelluto, Genova (IT)

(72) Inventors: Patrick Verbruggen, Orbais (BE); Sébastien De Neuter, Jandrenouille (BE); Roberto Marabotto, Genova (IT); Alessio Capelluto, Genova (IT)

(21) Appl. No.: 13/881,315

(22) PCT Filed: Oct. 25, 2011
(86) PCT No.: PCT/EP2011/068691

§ 371 Date: Jul. 1, 2013

(30) Foreign Application Priority Data
Oct. 26, 2010 (EP) 10188946.7

(51) Int. Cl. H05H 7/04

(52) U.S. Cl. CPC H05H 7/04
USPC 250/396 R

(57) ABSTRACT

A magnet structure for use in a circular ion accelerator, such as e.g. a synchrocyclotron comprises a cold-mass structure including superconducting magnetic coils (20, 25), at least one dry cryocooler unit (10, 11, 12, 13) coupled with the cold-mass structure for cooling the latter and a magnetic yoke structure (30) with a return yoke (35) configured radially around said coils (20, 25). The return yoke (35) comprises an opening in which said dry cryocooler unit (10, 11, 12, 13) is received so as to be in thermal contact with said cold-mass structure.

### TECHNICAL FIELD

The invention generally relates to a circular ion accelerator, more particularly to a superconducting synchrocyclotron. More specifically, the invention relates to a magnet structure for a circular ion accelerator, more particularly to a magnetic structure for a superconducting synchrocyclotron.

### DESCRIPTION OF PRIOR ART

A typical magnetic structure of a superconducting synchrocyclotron generally comprises a cold-mass structure including at least two superconducting magnetic coils, i.e. magnetic coils which comprise a material that is superconducting below a nominal temperature, and a bobbin associated with the magnetic coils. A cryostat generally encloses this cold mass structure and forms a vacuum chamber for keeping the cold mass structure under vacuum. The cold mass structure is cooled with one or more dry cryocooler units below the nominal temperature at which the magnetic coils are superconducting. The magnet structure further comprises a magnetic yoke structure surrounding the cryostat. Such a yoke structure generally comprises an upper part, a lower part, a pair of pole parts and a return yoke arranged radially around the magnetic coils.

U.S. Pat. No. 7,656,258 describes such a magnetic structure for generating a magnetic field in e.g. a superconducting synchrocyclotron. The magnet structure comprises several dry cryocooler units as shown in FIG. 10 of the referenced patent (units identified with reference number 26) to cool the cold-mass structure (21) below a temperature where the coils become superconducting. A first dry cryocooler unit (26) is positioned vertically on top of the upper part of the yoke (36) and extends vertically through a hole in the upper part of the yoke structure towards the cold mass structure (21). A second cryocooler unit (26) is positioned vertically below the lower part of the yoke structure (36) and extends vertically through a hole in the lower part of the yoke structure. Two additional dry cryocooler units (33) are installed on top of the upper part of the yoke structure and configured for cooling the current leads (37, 58) of the coils (12, 14). Such a vertical orientation of the dry cryocooler units is necessary for reaching the specified nominal refrigeration capacity (e.g. Gifford-McMahon type of cryocooler units). Other types of cryocooler units (e.g. pulse type of cryocooler unit) only operate in a vertical position.

Although the design of the magnetic structure as disclosed in U.S. Pat. No. 7,656,258 may work in a satisfactory manner, it has nevertheless some disadvantages.

A first disadvantage of the magnetic structure as disclosed in U.S. Pat. No. 7,656,258 resides in the fact that for each cryocooler unit installed in the upper, respectively lower part of the yoke structure, a corresponding hole must be made in a symmetrical way in the opposite lower part, respectively the opposite upper part of the yoke structure. This symmetry of the holes in the magnetic yoke structure is indeed necessary for warranting the required magnetic field properties. It will be appreciated that these supplementary holes result in an increased machining time when manufacturing the yoke structure. A great number of holes in the yoke structure also results in a second disadvantage, namely a reduction of the efficiency of the yoke structure and an increase of the magnetic stray field. A third disadvantage is due to the fact that vertically positioned dry cryocooler units increase the height of the accelerator and hence require a larger building with sufficiently high ceilings to house the cyclotron. Moreover, for maintenance purposes, such cyclotrons are opened by removing the upper part of the yoke structure. Hence, before opening the cyclotron, it is necessary to first disconnect the vertically arranged cryocooler units from the cold mass structure, which is a major fourth disadvantage. This fourth disadvantage further results in longer down time periods of cyclotron operation, when the cyclotron must be opened for e.g. maintenance purposes.

The publication of JOONSUN et al: “Design Study of a K22 Prototype Superconducting Cyclotron Magnet”, IEEE Transactions on Applied Superconductivity, IEEE Service Center Los Alamitos, Calif., US, vol. 20, no. 3, 1 Jun. 2010, pages 192-195, discloses a cryogenic system comprising three 1.5 W GM cryocoolers arranged in separate re-condensing vessels located laterally of the cyclotron. Conduits for evaporated and re-condensed helium pass through a radial opening in the upper half of a return yoke.

### SUMMARY OF THE INVENTION

It is an object of the invention to provide a magnetic structure for use in an ion accelerator (e.g. synchrocyclotron) which overcomes or alleviates at least some of the aforementioned problems of prior art magnetic structures.

This object is achieved by magnet structure in accordance with claim 1, respectively by a synchrocyclotron comprising such a magnet structure.

A magnet structure for use in a circular ion accelerator comprises a cold-mass structure including superconducting magnetic coils, at least one dry cryocooler unit coupled with the cold-mass structure for cooling the cold-mass structure and a magnetic yoke structure comprising a return yoke configured radially around the coils. In accordance with one aspect of the present invention, the return yoke comprises an opening in which the dry cryocooler unit is received so as to be in thermal contact with the cold-mass structure.

In a preferred embodiment, the dry cryocooler unit is received in the opening in a position essentially perpendicular to a central axis of the magnetic coils.

Preferably two dry cryocooler units are received in the same opening in the return yoke, wherein they are preferably superimposed at a same radial position. Indeed, by superimposing two cryocooler units at the same radial position with respect to the return yoke, the return flux of the magnetic field remains the same when compared to the use of a single cryocooler unit at the same radial position and hence there is no need to increase the diameter of the cyclotron to compensate for the loss of magnetic flux capacity when installing a second cryocooler unit for increasing the refrigeration capacity.

In a preferred embodiment, the return yoke comprises two openings spaced by an angle of 180°, wherein at least one cryocooler unit is received in each of these openings. Thus, symmetry of the yoke structure is warranted with a minimum of openings therein. Preferably, two cryocooler units are superimposed in each of these openings.

The cold-mass structure typically includes a bobbin associated with the superconducting magnetic coils, wherein the at least one cryocooler unit is advantageously in thermal contact with the bobbin.

The superconducting magnetic coils advantageously include a current lead that is in thermal contact with the cryocooler unit, so that the latter simultaneously cools the bobbin and the current lead. Hence, no dedicated or additional dry cryocooler units must be installed for cooling the current leads and, consequently, no additional openings must be made in the yoke structure

The cryocooler unit advantageously has a terminal cooling stage member that is in thermal contact with an outward wing of the bobbin, and the outward wing is in contact with a radial outer part of the magnetic coils.

In a preferred embodiment, the magnet structure has a central axis and a median plane perpendicular to the central axis, and the opening in which the dry cryocooler unit is received is symmetric with regard to the median plane.

The magnet structure typically comprises a cryostat enclosing the cold-mass structure and forming a vacuum chamber for keeping the cold-mass structure under vacuum. This vacuum chamber advantageously comprises a radial vacuum chamber extension in which at least one cooling stage of the dry cryocooler unit is housed. The latter advantageously includes a head part protruding out of the radial vacuum chamber extension.

A preferred embodiment of the magnet structure with a vacuum chamber for keeping the cold-mass structure under vacuum further comprises tie rods for supporting the cold-mass structure. Each of the tie rods is advantageously positioned partly within a hollow tube, which extends the vacuum chamber for passing through the yoke structure. At least one of these hollow tubes is advantageously coupled to a vacuum pump for creating a vacuum in the cryostat.

### SHORT DESCRIPTION OF THE DRAWINGS

These and further aspects of the invention will be explained in greater detail by way of example and with reference to the accompanying drawings in which:

FIG. 1 is a three-dimensional (3D) view of a synchrocyclotron comprising a magnetic structure according to the invention;

FIG. 2 is a schematic sectional view of the magnetic structure according to the invention, the sectional plane being a vertical plane containing the central axis of the synchrocyclotron;

FIG. 3 is an enlarged detail of FIG. 2 showing a configuration of dry cryocooler units in a magnetic structure according to the invention;

FIG. 4 is a schematic sectional view of a synchrocyclotron having a magnetic structure according to the invention, the sectional plane being the median plane of the synchrocyclotron, which is perpendicular to the central axis of the synchrocyclotron;

FIG. 5 is a three-dimensional (3D) view of a cryostat for a synchrocyclotron according to the invention; and

FIG. 6 is a three-dimensional (3D) view of the cryostat of FIG. 5 within a magnetic yoke structure.

The figures are not drawn to scale. Generally, identical components are denoted by the same reference numerals in the figures.

### DETAILED DESCRIPTION OF PREFERRED EMBODIMENTS

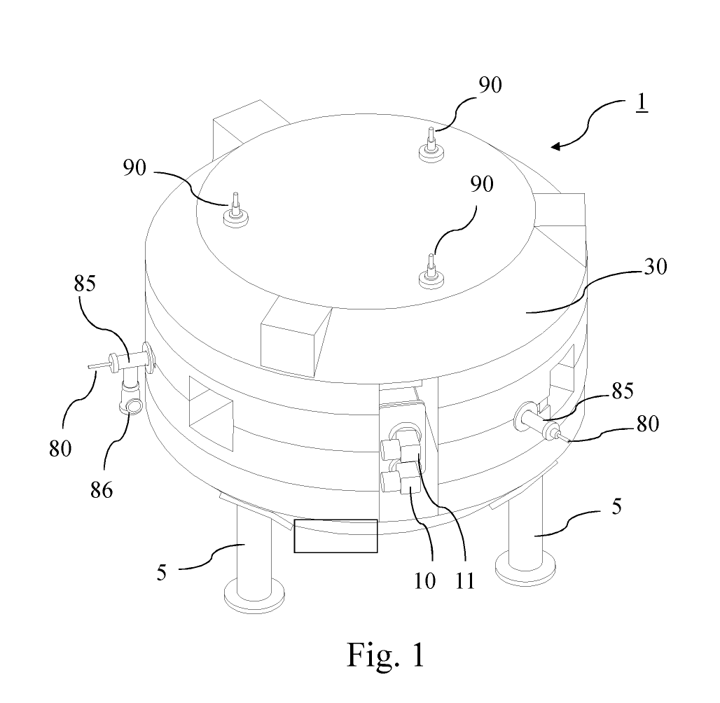

FIG. 1 shows, as an illustration of the invention, a three dimensional view of a preferred embodiment of a synchrocyclotron 1 comprising a magnetic structure according to the invention. It will be noted that, for the sake of clarity, the representation of the synchrocyclotron 1 is only schematic, and that not all its parts and details are shown. The major part of the magnetic structure that is visible from the outside of the synchrocyclotron is a magnetic yoke structure 30, which is usually made of ferromagnetic iron. The synchrocyclotron with its magnetic structure is supported on the floor by several feet 5.

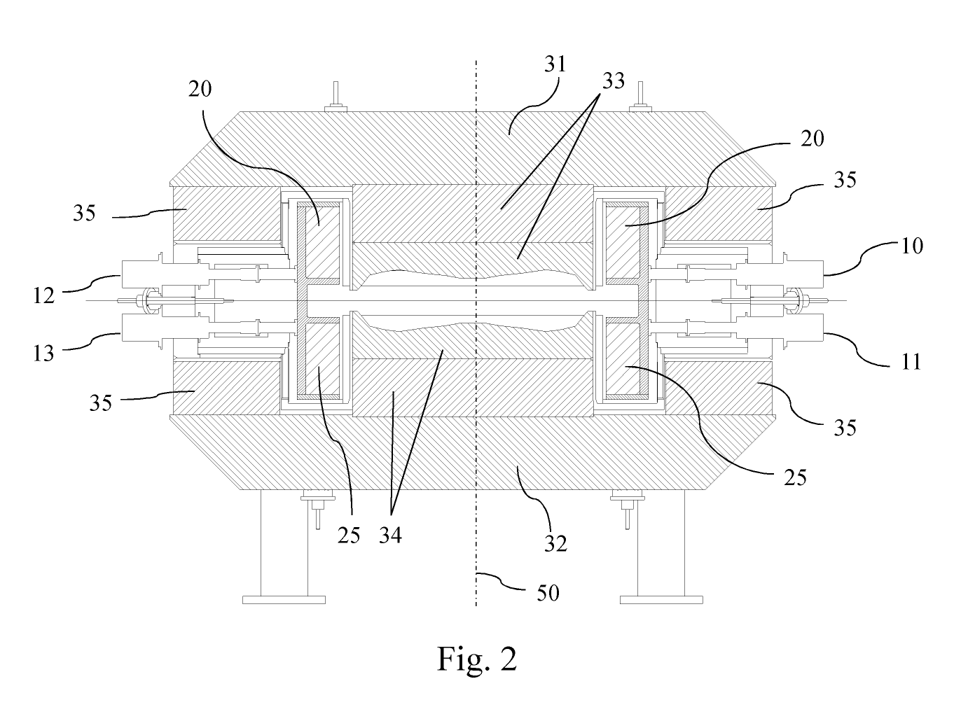

FIG. 2 is a schematic sectional view illustrating a preferred embodiment of magnetic structure according to the invention. The magnetic structure comprises two circular superconducting magnetic coils 20, 25. These coils have an annular shape and are superimposed symmetrically with regard to a median plane of the synchrocyclotron 1. To fix the ideas, it will be noted that the coils of the magnetic structure shown in FIG. 2 have e.g. an outer diameter of 1.370 m and an inner diameter of 1.108 m. These coils are generally named upper coil 20 and lower coil 25, respectively. The two coils 20, 50 have a common central axis 50, as indicated in FIG. 2, going axially through the centres of the coils. This central axis 50 is also forming a central axial axis for the entire magnetic structure.

The superconducting coils 20, 50 are generating a coil magnetic field in an axial direction, i.e. in a direction parallel with the central axis 50. They comprise e.g. NbTi as superconducting material and are typically operated at 4.5 K, with current densities of about 55.6 A/mm2 for providing a coil magnetic field of about 3.33 Tesla. Alternatively, other superconducting conductor materials can be used such as Nb-3Sn conductors.

As mentioned above, the magnet structure comprises a magnetic yoke structure 30, which consists of several parts. Following main parts of the yoke structure can be distinguished on FIG. 2: an upper yoke part 31, a lower yoke part 32, a pair of pole parts 33, 34 and a so-called return yoke 35. The return yoke 35 is radially arranged around the coils 20, 25. To fix the ideas, it will be noted that the return yoke 35 of FIG. 2 has e.g. an inner diameter of about 1.590 m and a radial thickness of about 0.455 m.

The superconducting coils 20, 25, together with the magnetic yoke structure generate a combined magnetic field between the two poles of the magnetic structure. The prototype referred herein is e.g. a 250 MeV proton synchrocyclotron having a magnetic structure designed for providing a total magnetic field of about 5.6 Tesla for bending protons during a circular acceleration process. To fix the ideas, it will be noted that the entire magnetic structure of such a synchrocyclotron has e.g. a diameter of about 2.5 m and a height of 1.56 m and has a total weight of about 45.000 kg.

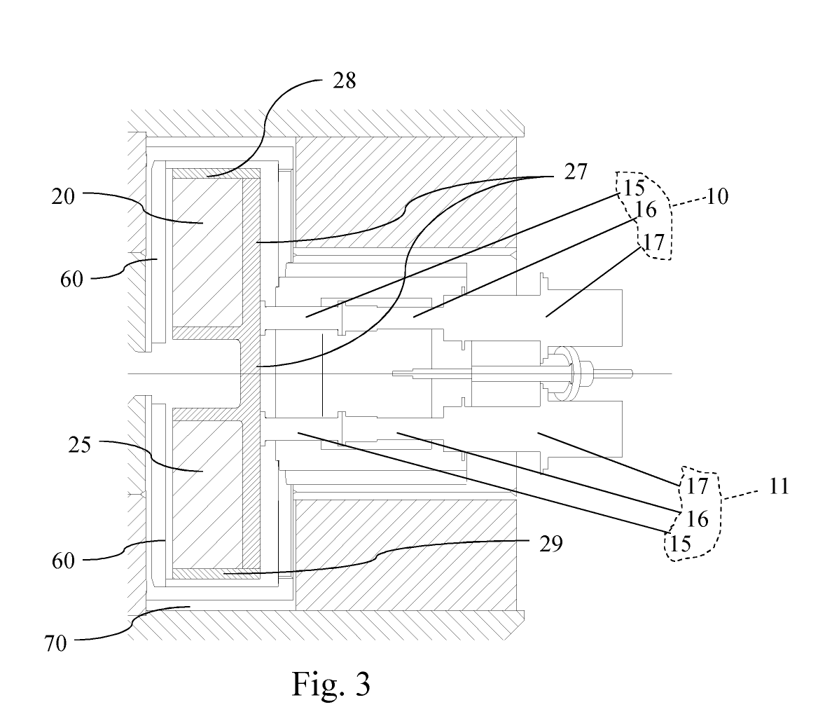

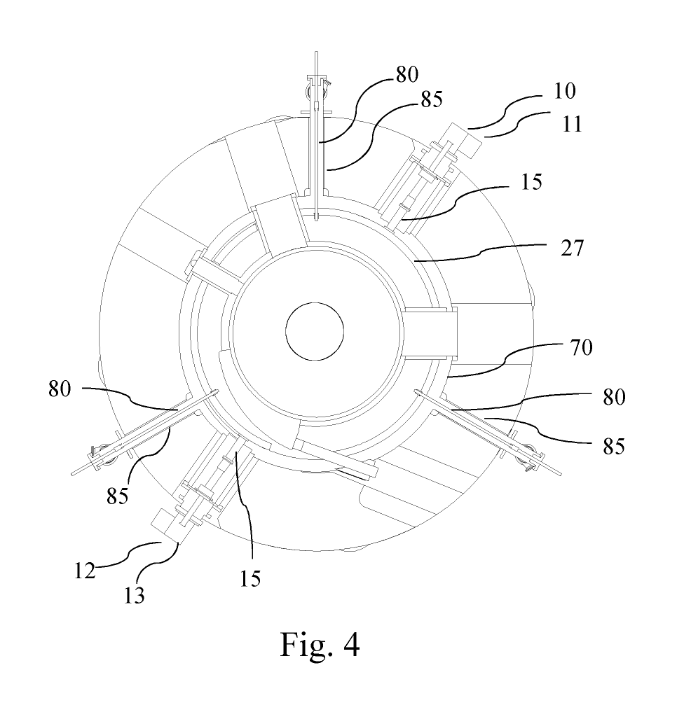

FIG. 3 is an enlarged view of part of the sectional illustration of FIG. 2. The superconducting coils 20, 25 are supported by a coil supporting structure which comprises a mechanical containment structure 27, referred to as bobbin 27, and coil supporting plates 28, 29. The bobbin is usually made of aluminium. When in operation, the upper and lower coils 20, 25 exercise large axial attractive forces on each other and also generate radial forces outward. The bobbin 27 is designed and has a shape for withstanding these forces: it has basically an outward wing that is contacting the radial outer part of the two coils and an inner wing in between the coils for withstanding axial attractive forces between the coils. Both the outer wing and inner wing of the bobbin have multiple holes for providing access to various parts of the synchrocyclotron. The bobbin 27 supporting the two coils 20, 25 is also thermally coupled with the two coils 20, 25. The coil supporting structure also comprises an upper and a lower 29 coil supporting plate having an annular shape and which are fixed to the bobbin 27. These coil supporting plates 28, 29 are preferably made of stainless steel. These coil supporting plates 28, 29 and the bobbin 27 cooperate for encapsulating and holding the coils in place. The coils 20, 25 are further surrounded by heat shields 60. Those heat shields are preferably made of an aluminium alloy. The upper and lower superconducting coils 20, 25 with the supporting structure 27, 28, 29 are called the cold-mass structure of the magnet structure, as these parts are kept below a temperature where the conductors of the coils 20, 25 are becoming superconducting. The whole cold-mass structure is preferably encapsulated in a cryostat 70 that is forming a vacuum chamber for keeping the cold-mass structure under vacuum (see e.g. FIGS. 4, 5 and 6).

The cold-mass structure is cooled by using a dry cryocooler unit. With the wording “dry” it is understood that the coils are maintained in a dry condition, i.e. they are not immersed in a cooling liquid (e.g. liquid He). Instead, the cold-mass structure is thermally coupled with one or more dry cryocooler units. These dry cryocooler units are commercially available.

As shown in FIG. 2 and FIG. 3, a through opening in a radial direction is made in the return yoke 35 for receiving a dry cryocooler unit 10. In this example, the dry cryocooler unit 10 is in a position in which its longitudinal axis is essentially perpendicular to the central axis 50 of the synchrocyclotron 1. In other words, if the synchrocyclotron 1 is positioned on the floor on its feet 5, as shown in FIG. 1, the dry cryocooler 10 unit is essentially in a horizontal position. When positioning a dry cryocooler unit 10 perpendicular to the central axis 50, there is a certain tolerance with respect to this orientation. In the example presented, the cryocooler unit 10 is preferably at an angle of 90°+/−5° with respect to the central axis 50 and more preferably at an angle of 90°+/−2°.

When the dry cryocooler unit (e.g. a dry cryocooler unit of the Gifford-McMahon type) is in such a horizontal position with respect to the floor, the refrigeration power will be lower than its nominal refrigeration power, i.e. the refrigeration power is typically reduced by 15%. For example, a dry cryocooler having a nominal refrigeration power of 1.5 W in a vertical position will only have a refrigeration power of 1.3 W in a horizontal position. With a refrigeration power of 1.3 W per cryocooler unit and with a synchrocyclotron in operation (i.e. producing beam), four dry cryocoolers units are needed to cool the cold-mass structure of the present example to a temperature of 4.5 K. In FIG. 2, the horizontal arrangement of the four cryocoolers 10,11,12,13 is shown.

Preferably, the opening in the return yoke 35 is configured such that it can receive two superimposed dry cryocooler units as shown in greater detail in FIG. 3. Both cryocooler units 10, 11 are preferably positioned to have their longitudinal axis perpendicular to the central axis 50 and more preferably the two dry cryocooler units are located at the same radial position with respect to the return yoke 35. In this way, the return flux of the magnetic field remains the same and there is no need to increase the diameter of the cyclotron to compensate for the loss of magnetic flux capacity due to the installation of a second dry cryocooler unit. To fix the ideas, it will be noted that the opening made through the return yoke 35 for receiving two superimposed cryocooler units is rectangular and has a height of about 50 cm and a width of about 29 cm.

As illustrated in FIG. 4, a second pair of cryocooler units 12, 13 is advantageously separated from a first pair of cryocooler units 10, 11 by a radial angle of 180°. Identical to the first pair of dry cryocooler units, also the second pair is received through an opening in the return yoke (see e.g. FIG. 2), preferably configured for receiving the two cryocooler units superposed at the same radial position.

Typically and as shown in FIG. 3, a dry cryocooler unit 10, 11 comprises a head part 17, a first stage member 16 and a second stage member 15. The head part comprises connection means for making connection with a cooling fluid compressor, e.g. a helium compressor (not shown). The first stage member 16 is at an intermediate temperature (for example 50 K) and a lowest temperature of for example 4.2 K is reached at the second stage member 15. The second stage member 15 is making a thermal contact with the cold mass structure such that the cold mass structure is cooled to a temperature where the conductors of the coils become superconducting (e.g. 4.5 K). More specifically, the second stage member 15 is making a thermal contact with the outward wing of the bobbin 27 (see e.g. FIG. 4). As in this preferred magnetic structure, two pair of superimposed dry cryocooler units are used, each second stage member 15 of each dry cryocooler unit is making a thermal contact with the outward wing of the bobbin 27 of the two coils 20, 25 as shown in FIG. 3 and FIG. 4.

The dry cryocooler units that are used for cooling the cold mass structure are at the same time also configured for gradually cooling the current leads of the two coils 20, 25 by making appropriate thermal contacts with the first stage and second stage members. In this way, no dedicated or additional dry cryocooler units need to be installed for cooling the current leads and hence no additional openings need to be made in the yoke structure 30.

As discussed above, the cold-mass structure is surrounded by a cryostat 70 and a vacuum is created in the cryostat to thermally insulate the cold-mass structure.

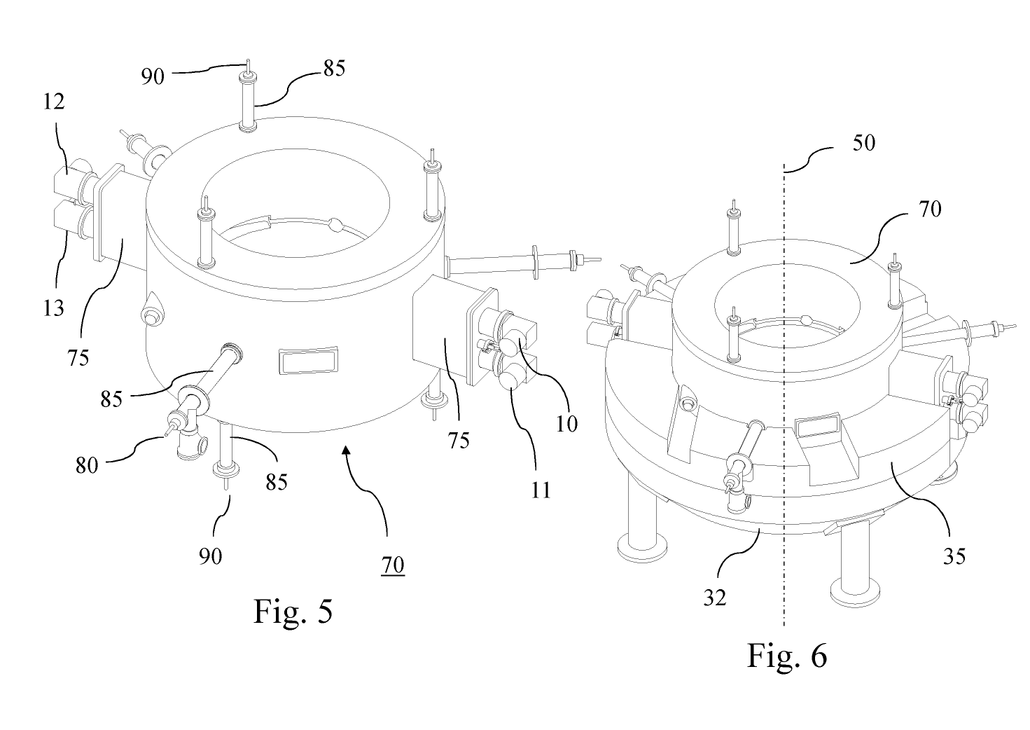

FIG. 5 shows a three dimensional view of the cryostat 70, whereas FIG. 6 shows its integration into the magnetic yoke structure (for clarity, only the lower part of the yoke 32 and only part of the return yoke 35 are shown in FIG. 6). This cryostat 70 having a shape of a hollow cylinder is made of stainless steel and has a wall thickness of e.g. 5 mm. The pair of horizontally mounted dry cryocooler units 10, 11 on one side of the cryostat and the pair of horizontally mounted dry cryocooler units 12, 13 on the other side of the cryostat are both coupled to the cryostat 70 by means of a radial cryostat vacuum chamber extension 75. This radial cryostat vacuum chamber extension 75 houses the first stage member 15 and the second stage member 16 of a pair of dry cryocooler units. In FIG. 5, solely the head part of the dry cryocooler 10, 11, 12, 13, which extends outside or partly outside the return yoke 35, is visible.

The heavy cold-mass structure, having a weight of about 4.300 kg, must be supported inside the cryostat 70. For this purpose, tension links 80, 90 are used, preferably both in the radial direction and the axial direction. Different types of tension links can be used. The preferred tension link is formed by a tied rod. As shown on FIGS. 1 and 5, three radial tension rods 80 and six axial tension rods 90 are attached to the cold-mass structure as supporting means. These tie rods are preferably made of Inconel. Radial tie rods have e.g. a diameter of 14 mm, while the axial tie rods have e.g. a diameter of 8 mm. From the six axial tie rods 90, three pass through the upper yoke part 31 and three pass through the lower yoke part 32. The three radial tie rods 80 pass through the return yoke 35. For passing through the various parts of the yoke structure 30, each of the axial 90 and radial 80 tie rods is mounted partially within a hollow tube 85 that is fixed to the exterior of the cryostat 70 as shown in FIG. 4 and FIG. 5. These hollow tubes 85 are part of the cryostat vacuum chamber and are hence vacuum-tight, just as the cryostat body.

As mentioned above, a vacuum is created within the cryostat 70. To create this vacuum, a tube connection piece 86 is advantageously connected to one of the hollow tubes 85, as illustrated in FIG. 1. A vacuum pump can then be connected to this connection piece 86 for creating a vacuum inside the cryostat 70. The advantage of this configuration, where a connection piece 86 is connected to a hollow tube 85 enclosing a tie rod 80, is that no additional specific opening must be made in the yoke structure 30 for installing a pumping tube coupled on one end to the cryostat 70 and on the other end to a vacuum pump installed outside the magnetic structure. With this configuration, a hollow tube 86 plays the role of being at the same time a housing of a tie rod 80 for supporting the cold mass-structure and a pumping channel for pumping vacuum inside the cryostat 70.

The present invention has been described with regard to a preferred embodiment of a magnet structure for use in a synchrocyclotron. The embodiment described is e.g. capable of providing a magnet field of about 5.6 T and designed for use in a 250 MeV proton synchrocyclotron. The dry cryocooler units that are installed through openings in the return yoke of the magnet structure are positioned in an essentially perpendicular position with respect to the central axis 50 of the coils. As discussed above, the dry cryocooler units are preferably installed at an angle of 90°+/−5° with respect to the central axis 50 and more preferably at an angle of 90°+/−2°. However, the detailed description of this embodiment just illustrates the invention and may not be construed as limiting.

More specifically, in alternative embodiments, the dry cryocooler units installed in openings of through the return yoke may not have an orientation perpendicular with respect to the central axis of the synchrocyclotron 1. Thus, the longitudinal axis of the dry cryocooler unit may define an angle smaller than 90° with the central axis of the synchrocyclotron 1, for example an angle of 80°. The invention is of course also applicable to other kinds of circular accelerators (such as e.g. a cyclotron) and to other magnet field strengths.

More generally, it will be appreciated by persons skilled in the art that the present invention is not limited by what has been particularly shown and/or described hereinabove. The invention resides in each and every novel characteristic feature and each and every combination of characteristic features.

Reference numerals in the claims do not limit their protective scope.

Use of the verbs “to comprise”, “to include”, “to be composed of”, or any other variant, as well as their respective conjugations, does not exclude the presence of parts other than those stated.

Use of the article “a”, “an” or “the” preceding an element does not exclude the presence of a plurality of such elements.

### REFERENCE SIGNS LIST

01 synchrocyclotron
05 foot
10,11 first pair of cryocooler units
12,13 second pair of cryocooler units
15 second stage member
16 first stage member
17 head part
20 superconducting magnetic coil (upper coil)
25 superconducting magnetic coil (lower coil)
27 bobbin
28,29 coil supporting plates
30 magnetic yoke structure
31 upper yoke part
32 lower yoke part
33,34 pair of pole parts
35 return yoke
50 common central axis
60 heat shield
70 cryostat
75 cryostat vacuum chamber extension
80 radial tension rod
85 hollow tube
86 tube connection piece
90 axial tension rod

1. A magnet structure for use in a circular ion accelerator comprising:
a cold-mass structure including superconducting magnetic coils;
at least one dry cryocooler unit coupled with the cold-mass structure and configured to cool the cold-mass structure; and
a magnetic yoke structure including a return yoke configured radially around the superconducting magnetic coils;
wherein the return yoke comprises an opening in which the at least one dry cryocooler unit is received so as to be in thermal contact with the cold-mass structure.

2. The magnet structure according to claim 1, wherein the at least one dry cryocooler unit is received in the opening in a position essentially perpendicular to a central axis of the superconducting magnetic coils.

3. The magnet structure according to claim 1, wherein two dry cryocooler units are received in the opening in the return yoke.

4. The magnet structure according to claim 3, wherein the two dry cryocooler units are superimposed at a same radial position.

5. The magnet structure according to claim 1, comprising two openings spaced by an angle of 180° in the return yoke, wherein at least one cryocooler unit is received in each of the two openings.

6. The magnet structure according to claim 5, wherein two cryocooler units are superimposed in each of the two openings.

7. The magnet structure according to claim 1, wherein the cold-mass structure includes a bobbin associated with the superconducting magnetic coils, and the at least one dry cryocooler unit is in thermal contact with the bobbin.

8. The magnet structure according to claim 7, wherein the superconducting magnetic coils includes a current lead that is in thermal contact with the at least one dry cryocooler unit, so that the at least one dry cryocooler unit simultaneously cools the bobbin and the current lead.

9. The magnet structure according to claim 7, wherein the at least one dry cryocooler unit comprises a terminal cooling stage member that is in thermal contact with an outward wing of the bobbin, and the outward wing is in contact with a radial outer part of the magnetic coils.

10. The magnet structure according to claim 1, wherein the magnet structure has a central axis and a median plane perpendicular to the central axis, and the opening in which the at least one dry cryocooler unit is received is symmetric with regard to the median plane.

11. The magnet structure according to claim 1, comprising a cryostat enclosing the cold-mass structure and forming a vacuum chamber for keeping the cold-mass structure under vacuum, the vacuum chamber comprising a radial vacuum chamber extension, and the at least one dry cryocooler unit including at least one cooling stage housed in the vacuum chamber extension, and a head part with a connector protruding out of the radial vacuum chamber extension.

12. The magnet structure according to claim 11, further comprising tie rods configured to support the cold-mass structure, each of the tie rods being positioned partly within a hollow tube, which extends the vacuum chamber for passing through the magnetic yoke structure.

13. The magnet structure according to claim 12, wherein at least one of the hollow tubes is coupled to a vacuum pump configured to create a vacuum in the cryostat.

14. (canceled)

15. The magnet structure according to claim 1, wherein:
the cold mass structure includes at least two superconducting magnetic coils comprising a material being superconducting below a nominal temperature, the at least two superconducting magnetic coils being configured for having a common central axis; and a bobbin configured to support the at least two superconducting magnetic coils; and the magnet structure further includes:
a cryostat enclosing the cold-mass structure and forming a vacuum chamber for keeping the cold-mass structure under vacuum, wherein the magnetic yoke structure surrounds the cryostat.

16. A synchrocyclotron comprising a magnet structure according to claim 1.
